(19) United States
(12) Patent Application Publication
(10) Pub. No.: US 2020/0223733 A1
(43) Pub. Date: Jul. 16, 2020

(54) LARGE MELTING FURNACE SUITABLE FOR BOROSILICATE GLASS

(71) Applicant: CHINA TRIUMPH INTERNATIONAL ENGINEERING CO., LTD., SHANGHAI (CN)

(72) Inventors: SHOU PENG, SHANGHAI (CN); QING LIU, SHANGHAI (CN); LONGYUE JIANG, SHANGHAI (CN); YANPING CAO, SHANGHAI (CN); XIAOLONG WANG, SHANGHAI (CN)

(73) Assignee: CHINA TRIUMPH INTERNATIONAL ENGINEERING CO., LTD., SHANGHAI (CN)

(21) Appl. No.: 16/752,629

(22) Filed: Jan. 25, 2020

Related U.S. Application Data
(63) Continuation-in-part of application No. 15/511,840, filed on Sep. 8, 2017, now abandoned.

(30) Foreign Application Priority Data
Sep. 16, 2014 (CN) 201410470089.8

(51) Int. Cl. C03B 5/03; C03B 5/18; C03B 5/20; C03B 5/225

(52) U.S. Cl. CPC C03B 5/03; C03B 5/2252; C03B 5/20; C03B 5/18

(57) ABSTRACT

A large melting furnace suitable for borosilicate glass. The melting furnace includes a melting area, a reinforcing area, an ascending area and a clarifying area. The melting area includes no furnace crown, a surface of molten glass in the melting area is not covered by any wall and exposed for feeding. The reinforcing area includes a first furnace crown, the first furnace crown includes a first partition wall and a second partition wall, and the reinforcing area and the melting area are separated by the first partition wall, and a lower end of the first partition wall goes deep below a surface of molten glass but is not in contact with a bottom of the melting furnace, so as to guarantee that the molten glass in the melting area and the reinforcing area is interconnected.

### CROSS REFERENCE TO RELATED APPLICATION

This application is a continuation-in-part application of U.S. Ser. No. 15/511,840 with a filing date of Sep. 8, 2017, the U.S. Ser. No. 15/511,840 is the US national stage of PCT/CN2015/077769 filed on Apr. 29, 2015 claiming the priority of CN201410470089.8 filed on Sep. 16, 2014, all applications are incorporated herein by reference.

### FIELD OF THE DISCLOSURE

The present disclosure relates to a technical field of glass melting equipment, and in particular to a melting furnace suitable for borosilicate glass. The melting furnace combines electric melting and flame melting, has a special structural design, and is a borosilicate glass melting furnace having a large production capacity.

### DESCRIPTION OF RELATED ARTS

Borosilicate glass has features such as high viscosity, high melting temperature, boron volatility and boron and silicon phase splitting. If a single flame melting mode is used and heating is performed by virtue of spatial radiation, not only heating efficiency will be lower and melting effect will be poor when melting glass which is very difficult to melt, but also the disturbance of flame will increase the amount of volatilized boron.

The full-electric melting technique is used for small glass melting furnaces having a production capacity below 15t/d, is an economic and applicable melting process and is particularly applicable to glass having highly-volatile components, glass having high melting temperature and special glass. At present, for borosilicate glass, this type of small full-electric melting furnace is mainly used for producing some glass products which are not produced in a mass, such as glass utensils, glass tubes and glass rods. To view from practical production experiences, for the full-electric melting furnaces having a production capacity above 20t/d, since the number of electrodes is increased, current distribution is more complex during a melting process, the uniformity of molten glass is poorer and the number of stripes in glass products is greater.

For borosilicate glass, especially high borosilicate glass, since thermal properties thereof are excellent, the application field thereof is increasingly wide. Particularly, panel borosilicate glass is used in various fields such as glass substrates, instrument glass, heat-resistant glass windows and flameproof glass. In order to satisfy the requirements of high-capacity panel glass formation process, the production capacity of a melting furnace has to match therewith. However, regarding the problem of boron volatilization brought about by reducing flame combustion, to view from the mechanism of boron volatilization, during a process that powder batch is converted into molten glass, the batch containing boron is decomposed once heating and reacts with other oxides in the batch to form various compounds having a higher melting point. During this process, a great amount of gas and water is discharged from the batch with the increase of temperature and the proceeding of reaction, boron oxide is volatilized therewith and the amount of volatilized boron accounts for about 91% of the whole-process volatilization amount. However, when a great amount of molten glass is produced, high-viscosity molten glass causes the speed that boron oxide is diffused to the surface to become very low, the amount of volatilized boron oxide at this stage only accounts for about 9% of the whole-process volatilization amount. Therefore, in order to decrease the volatilization of boron oxide, a melting area should adopt a cold heading mode, and flame combustion has to be fully separated from the powder batch.

Accordingly, it can be seen that high-quality borosilicate molten glass can be obtained by adopting a large melting furnace, as long as a suitable melting furnace structure is adopted, the volatilization of boron oxide during the process that the borosilicate batch is converted into molten glass is avoided and the uniformity of the molten glass is increased.

### SUMMARY

The present disclosure provides a large melting furnace for borosilicate glass, which is combined with the advantages of flame melting and electric melting techniques and is a melting furnace having a production capacity above 20t/d.

The present disclosure provides a large melting furnace suitable for borosilicate glass. The melting furnace includes a melting area, a reinforcing area, an ascending area and a clarifying area. The melting area includes no furnace crown and has a open top, the open crown is exposed for feeding powder batch to form a thick powder batch layer on a surface of molten glass in the melting area to separate the molten glass to contact with air and flame heating, the thick powder batch layer enables boron oxide volatilized from the molten glass in the melting area to be condensed in the powder batch layer and to flow back into the molten glass, thereby decreasing the volatilization of boron oxide.

The reinforcing area includes a first furnace crown, the first furnace crown includes a first partition wall and a second partition wall, and the reinforcing area and the melting area are separated by the first partition wall, and a lower end of the first partition wall goes deep below a surface of molten glass but is not in contact with a bottom of the melting furnace, so as to guarantee that the molten glass in the melting area and the reinforcing area is interconnected. The ascending area and the reinforcing area are separated by the second partition wall, a lower end of the second partition wall goes deep below the surface of molten glass but is not in contact with the bottom of the melting furnace, so as to guarantee that the molten glass in the reinforcing area and the ascending area is interconnected. The clarifying area is interconnected with the ascending area. A second furnace crown is placed above the surface of molten glass in the ascending area and the clarifying area, the second furnace crown includes a vertical sidewall and a top wall connected with the vertical sidewall and the second partition wall.

The melting furnace further includes a partition plate extending from the second partition wall to the vertical sidewall in a space above the surface of the molten glass in the ascending area and the clarifying area to form a closed space with the top wall of the second furnace crown, and the melting furnace further includes silicon-carbon rods placed in the closed space between the partition plate and the top wall of the second furnace crown, to perform radiation heating to the molten glass, so as to reduce the viscosity of the molten glass and accelerate the exhaust of the air bubbles in the molten glass. The heat loss is greatly reduced.

In some embodiments, the reinforcing area adopts a mixed heating mode, wherein flame heating is adopted for a surface of the molten glass and electrode heating is adopted for a bottom of the melting furnace.

In some embodiments, the flame heating is full-oxygen combustion, oxygen-supported combustion or air combustion.

In some embodiments, the melting area adopts electrode heating to arrange heating electrodes at a bottom of the melting area.

In some embodiments, the molten glass enters the ascending area through a throat at a bottom of a tail end of the reinforcing area.

In some embodiments, the ascending area is provided with a homogenization device.

In some embodiments, the homogenization device is a bubbling device, a mechanical mixing device or an ultrasonic device.

In some embodiments, the clarifying area is shallower than the melting area, the reinforcing area and the ascending area.

In some embodiments, an electric heating and negative pressure system is arranged in a space above the surface of the molten glass in the clarifying area.

In some embodiments, the electric heating and negative pressure system in the clarifying area adopts silicon-carbon rods for heating the surface of the molten glass, and adopts a mechanical air exhaust mode to guarantee a negative pressure state of the clarifying area.

According to the large melting furnace suitable for borosilicate glass, the structures of the melting area and reinforcing area can also improve the problem of boron volatilization of the borosilicate glass during a melting process caused by flame melting. The molten glass flows out from the throat of the reinforcing area, passes through the ascending area and enters a shallower clarifying area. By means of the homogenization device arranged in the ascending area and the electric heating and negative pressure system arranged in the clarifying area, the molten glass is sufficiently homogenized and clarified.

The present disclosure will be described below through examples with reference to the drawings, such that other aspects and advantages of the present disclosure can be clearly understood.

### BRIEF DESCRIPTION OF THE DRAWINGS

With reference to the drawings, through the detailed description below, the above-mentioned and other features and advantages of the present disclosure can be more clearly understood, wherein:

FIG. 1 illustrates an elevation view of a borosilicate glass melting furnace according to an embodiment of the present disclosure; and

FIG. 2 illustrates a plan view of a borosilicate glass melting furnace according to an embodiment of the present disclosure.

### DETAILED DESCRIPTION OF THE PREFERRED EMBODIMENTS

With reference to the specific embodiments and drawings of the present disclosure, the present disclosure will be described below in more detail. However, the present disclosure may be implemented in many different modes and shall not be understood as limited by the embodiments provided herein. Contrarily, these embodiments are provided in order to achieve full and complete disclosure and allow one skilled in the art to fully understand the scope of the present disclosure.

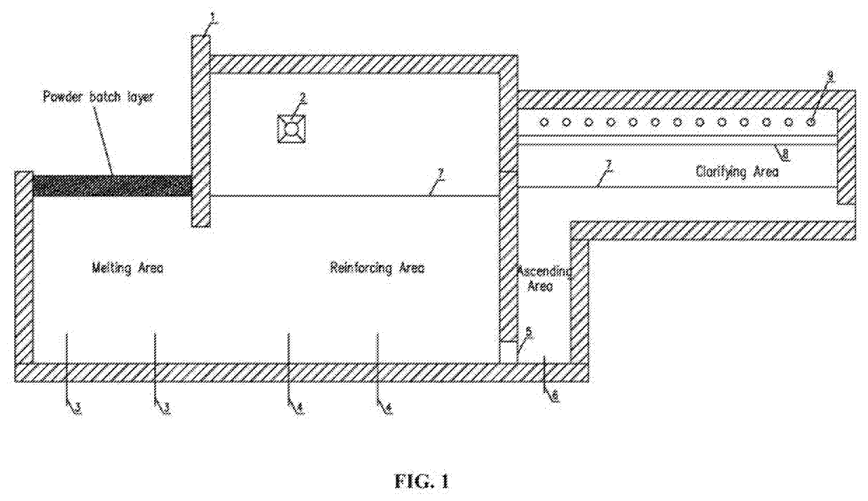

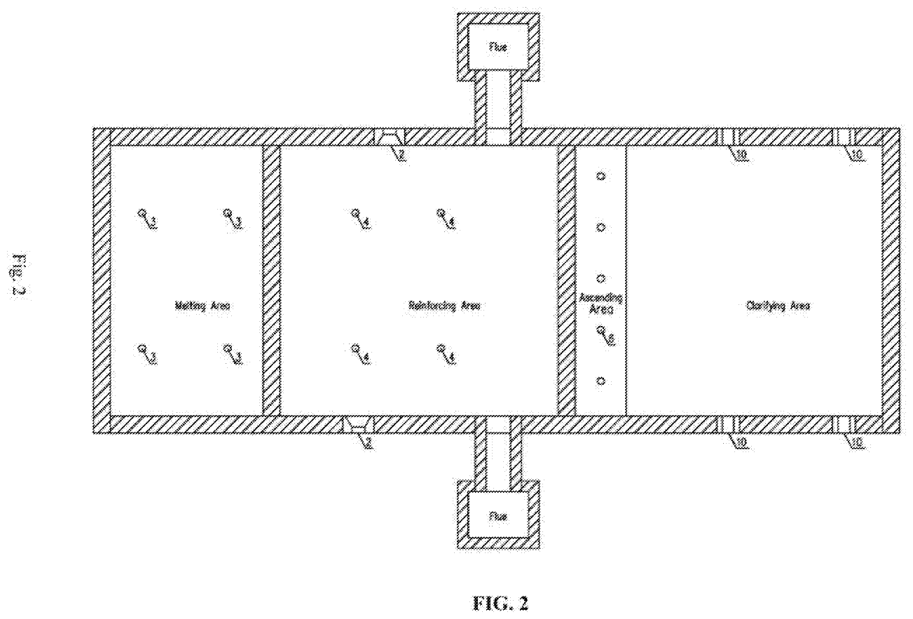

Referring to FIG. 1 and FIG. 2, the large melting furnace suitable for borosilicate glass according to the embodiment of the present disclosure will be described in detail.

As illustrated in FIG. 1 and FIG. 2, the melting furnace includes a tank containing molten glass. The melting furnace includes a melting area, a reinforcing area, an ascending area and a clarifying area.

The melting area includes no furnace crown and has a open top, the open crown is exposed for feeding powder batch to form a thick powder batch layer on a surface of molten glass in the melting area to separate the molten glass to contact with air and flame heating, the thick powder batch layer enables boron oxide volatilized from the molten glass in the melting area to be condensed in the powder batch layer and to flow back into the molten glass, thereby decreasing the volatilization of boron oxide.

The reinforcing area includes a first furnace crown, the first furnace crown includes a first partition wall 1 and a second partition wall, and the reinforcing area and the melting area are separated by the first partition wall 1, and a lower end of the first partition wall goes deep below a surface of molten glass but is not in contact with a bottom of the melting furnace, so as to guarantee that the molten glass in the melting area and the reinforcing area is interconnected.

The ascending area and the reinforcing area are separated by the second partition wall, a lower end of the second partition wall goes deep below the surface of molten glass but is not in contact with the bottom of the melting furnace, so as to guarantee that the molten glass in the reinforcing area and the ascending area is interconnected. The clarifying area is interconnected with the ascending area.

A second furnace crown is placed above the surface of molten glass in the ascending area and the clarifying area, the second furnace crown includes a vertical sidewall and a top wall connected with the vertical sidewall and the second partition wall.

The melting furnace further includes a partition plate 8 extending from the second partition wall to the vertical sidewall in a space above the surface of the molten glass in the ascending area and the clarifying area to form a closed space with the top wall of the second furnace crown, and the melting furnace further includes silicon-carbon rods placed in the closed space between the partition plate and the top wall of the second furnace crown, to perform radiation heating to the molten glass, so as to reduce the viscosity of the molten glass and accelerate the exhaust of the air bubbles in the molten glass. The heat loss is greatly reduced.

In some embodiments, the reinforcing area adopts a mixed heating mode, wherein flame heating is adopted for a surface of the molten glass, and electrode heating is adopted for a bottom of the melting furnace. The flame heating may be full-oxygen combustion, oxygen-supported combustion or air combustion. The electrode heating comprises arranging heating electrodes at a bottom of the melting area.

In some embodiments, the molten glass enters the ascending area through a throat at a bottom of a tail end of the reinforcing area. The ascending area is provided with a homogenization device. The homogenization device may be a bubbling device, a mechanical mixing device or an ultrasonic device. The ultrasonic device includes an ultrasonic generator and a control system. The control system controls the ultrasonic generator to homogenize molten glass through ultrasound. The clarifying area is shallower than the melting area, the reinforcing area and the ascending area.

In some embodiments, an electric heating and negative pressure system is arranged in a space above the surface of the molten glass. The electric heating and negative pressure system in the clarifying area adopts silicon-carbon rods for heating the surface of the molten glass, and adopts a mechanical air exhaust mode to guarantee a negative pressure state of the clarifying area.

A full-oxygen combustion mode is selected for the flame melting part in this embodiment, and as illustrated in the drawings, the melting furnace is divided into a melting area, a reinforcing area, an ascending area and a clarifying area, wherein two smoke exhaust flues are arranged at two sides of a furnace body in the reinforcing area.

The melting area and the reinforcing area of the melting furnace provided by the present disclosure is separated by a partition wall 1 near level line 7, and the insertion depth into the molten glass level line 7 can be adjusted by the partition wall 1. Below the partition wall 1, the melting area and the reinforcing area are interconnected.

A fully open feed inlet is provided at the top cap of the melting area. When feeding, powder batch is uniformly fed above the molten glass in the melting area through a feeder, heating electrodes 3 are arranged at a bottom of the melting area, the power of the heating electrodes 3 must guarantee that the surface of the melting area is covered with a thick powder batch layer, and temperature of the surface of the powder batch layer is as low as possible to enable boron oxide volatilized from the molten glass in the melting area to be condensed in the batch covering layer and to flow back into the molten glass, such that the volatilization of boron oxide is decreased.

A bottom of the melting furnace in the reinforcing area is heated from the bottom thereof by adopting electrodes 4, a flame combustion spray gun opening 2 is arranged at a sidewall of the melting furnace and is used for erecting a full-oxygen spray gun. Flame heating is adopted in a space above the level line 7. A mode combining electrode hating and flame heating improves the melting quality of the molten glass increased the uniformity of the molten glass and is suitable for a melting furnace having a great production capacity. Since the partition wall 1 separates the flame space from the powder batch, the disturbance caused by flame combustion to the powder batch is decreased and thus the volatilization of boron oxide is decreased. Flues at the two sides of the melting furnace are used for exhausting waste gas produced during flame combustion.

The molten glass in the reinforcing area passes through a throat 5 between the reinforcing area and the ascending area and enters the ascending area. The throat 5 is located at a position close to the bottom of the melting furnace. A bubbling device 6 is arranged at a bottom of the ascending area to decrease the accumulation of aluminum elements having a larger proportion at a dead corner of the ascending area during the fluxion of the molten glass, and to increase the uniformity of the molten glass.

The ascending area and the clarifying area are located in a comparatively close space, and the clarifying area is shallower. A depressurization device is arranged at a mechanical air exhaust outlet 10 at the sidewall of the melting furnace in the clarifying area to reduce the pressure in the space above the molten glass level line 7 in the ascending area and the clarifying area and accelerate the exhaust of air bubbles in the molten glass. Besides, a partition plate 8 is arranged in the space above the molten glass level line 7 in the ascending area and the clarifying area, and silicon-carbon rods 9 are used above the partition plate 8 for performing radiation heating to the molten glass, so as to reduce the viscosity of the molten glass and accelerate the exhaust of the air bubbles in the molten glass.

According to the large melting furnace suitable for borosilicate glass provided by the embodiment of the present disclosure, the structures of the melting area and reinforcing area can also improve the problem of boron volatilization of the borosilicate glass caused by flame melting during the melting process. The molten glass flows out from the throat of the reinforcing area, passes through the ascending area and enters the shallower clarifying area. By means of the homogenization device arranged in the ascending area and the electric heating and negative pressure system arranged in the clarifying area, the molten glass is sufficiently homogenized and clarified.

The preferred specific embodiments of the present disclosure are described above in detail. It should be understood that various modifications and variations may be made by one skilled in the art according to the concept of the present disclosure without contributing any inventive labor. All technical solutions, which can be obtained by one skilled in the art according to the concept of the present disclosure on the basis of the prior art through logical analysis, reasoning or limited tests, shall be included in the protection scope determined by the claims.

What is claimed is:

1. A large melting furnace suitable for borosilicate glass, comprising:
a melting area including no furnace crown, the open crown is exposed for feeding powder batch to form a thick powder batch layer on a surface of molten glass in the melting area to separate the molten glass to contact with air and flame heating, the thick powder batch layer enables boron oxide volatilized from the molten glass in the melting area to be condensed in the powder batch layer and to flow back into the molten glass, thereby decreasing the volatilization of boron oxide;
a reinforcing area including a first furnace crown, wherein the first furnace crown includes a first partition wall and a second partition wall, and the reinforcing area and the melting area are separated by the first partition wall, and a lower end of the first partition wall goes deep below a surface of molten glass but is not in contact with a bottom of the melting furnace, so as to guarantee that the molten glass in the melting area and the reinforcing area is interconnected;
an ascending area, wherein the ascending area and the reinforcing area are separated by the second partition wall, a lower end of the second partition wall goes deep below the surface of molten glass but is not in contact with the bottom of the melting furnace, so as to guarantee that the molten glass in the reinforcing area and the ascending area is interconnected;
a clarifying area interconnected with the ascending area;
a second furnace crown is placed above the surface of molten glass in the ascending area and the clarifying area, the second furnace crown includes a vertical sidewall and a top wall connected with the vertical sidewall and the second partition wall;
the melting furnace further includes a partition plate extending from the second partition wall to the vertical sidewall in a space above the surface of the molten glass in the ascending area and the clarifying area to form a closed space with the top wall of the second furnace crown;
and
the melting furnace further includes silicon-carbon rods placed in the closed space between the partition plate and the top wall of the second furnace crown.

2. The melting furnace according to claim 1, characterized in that the reinforcing area adopts a mixed heating mode, wherein flame heating is adopted for a surface of the molten glass and electrode heating is adopted for a bottom of the melting furnace.

3. The melting furnace according to claim 2, characterized in that the flame heating includes full-oxygen combustion, oxygen supported combustion or air combustion.

4. The melting furnace according to claim 1, characterized in that the melting area adopts electrode heating to arrange heating electrodes at a bottom of the melting area.

5. The melting furnace according to claim 1, characterized in that the molten glass enters the ascending area through a throat at a bottom of a tail end of the reinforcing area.
The melting furnace according to claim 5, characterized in that the ascending area is provided with a homogenization device.

7. The melting furnace according to claim 6, characterized in that the homogenization device includes an ultrasonic device to homogenize molten glass through ultrasound.

8. The melting furnace according to claim 1, characterized in that the clarifying area is shallower than the melting area, the reinforcing area and the ascending area.

9. The melting furnace according to claim 8, characterized in that a negative pressure system is arranged in a space above the surface of the molten glass in the clarifying area.

10. The melting furnace according to claim 9, characterized in that the negative pressure system in the clarifying area adopts a mechanical air exhaust mode to guarantee a negative pressure state of the clarifying area.
